(19) United States
(12) Patent Application Publication
(10) Pub. No.: US 2022/0243530 A1
(43) Pub. Date: Aug. 4, 2022

(54) HEM LENGTH ADJUSTING DEVICE FOR WINDOW BLIND WITHOUT EXPOSED PULL CORD

(71) Applicant: SHEEN WORLD TECHNOLOGY CORPORATION, Taichung City (TW)

(72) Inventor: Po-Yu CHEN, Taichung City (TW)

(21) Appl. No.: 17/161,991

(22) Filed: Jan. 29, 2021

(51) Int. Cl. E06B 9/68; E06B 9/58; E06B 9/66

(52) U.S. Cl. CPC E06B 9/68; E06B 2009/583; E06B 9/66; E06B 9/58

(57) ABSTRACT

A hem length adjusting device for a window blind without exposed pull cord includes a base, a first worm shaft disposed in the base, and a second worm shaft disposed in the base. The base is mounted in a bottom rail and has a first hole for penetration of a lifting hole. The first worm shaft has a driving hole exposed out of the bottom side of the bottom rail for engagement with a hand tool. The second worm shaft is meshed with the first worm shaft so as to driven by the first worm shaft to rotate for winding the bottom end of the lift cord. By this way, because the top end of the lift cord is kept still, the bottom rail is raised when the lift cord is wound around the second worm shaft, thereby adjusting the height above the ground of the bottom rail.

### BACKGROUND OF THE INVENTION

### 1. Field of the Invention

The present invention relates to window blinds without exposed pull cord and more particularly, to a hem length adjusting device for the window blind without exposed pull cord.

### 2. Description of the Related Art

A conventional window blind without exposed pull cord utilizes the torsion force of a metal spring to balance with the counterweight of a bottom rail, enabling the slats to be folded or unfolded, thereby improving the safety concerns of traditional pull-cord window blind.

For the window blind without exposed pull cord, the height of a window is very important. If the position of the window is too low, it is easy for the bottom rail to touch the ground after the slats are unfolded. In order to solve the aforesaid problems, a user usually tries to adjust the vertical unfolding length of the window blind. However, the slats may be folded automatically because the force applied by the user to the bottom rail is not controlled properly, such that the user needs to operate repeatedly to complete the unfolding length adjustment of the window blind. An improvement in this regard is desired.

### SUMMARY OF THE INVENTION

It is a primary objective of the present invention to provide a hem length adjusting device for a window blind without exposed pull cord, which is used to adjust the height above the ground of a bottom rail according to different environment, thereby enhancing the convenience of operation.

To attain the above objective, the hem length adjusting device of the present invention comprises a base, a first worm shaft, and a second worm shaft. The base is mounted in a bottom rail and has a first hole for penetration of a lifting cord. The first worm shaft is rotatably disposed in the base and has a head portion protruding from the bottom side of the bottom rail and provided with a driving hole for engagement with a hand tool (such as a screwdriver), a first shaft portion provided with a bottom end thereof connected with the head portion, and a first worm teeth portion formed on the outer surface of the fist shaft portion. The second worm shaft is rotatably disposed in the base and arranged in a vertical manner relative to the first worm shaft, and further, the second worm shaft has a second shaft portion connected with the bottom end of the lifting cord, and a second worm teeth portion formed on the outer surface of the second shaft portion and meshed with the first worm teeth portion of the first worm shaft.

It can be understood from the above illustration that when the first worm shaft is driven by the hand tool to rotate, the second worm shaft is driven by the first worm shaft to rotate for winding the lift cord. Because of connecting with a cord rolling device, the top end of the lifting cord is kept still, such that the bottom rail is raised when the bottom end of the lift cord is wound around the second worm shaft. Thus, the height above the ground of the bottom rail can be adjusted conveniently.

Preferably, the second worm shaft further has an annular convex portion formed on the outer surface of the second shaft portion and connected with the bottom end of the lifting cord.

Preferably, the second worm shaft further has a second hole passing radially through the annular convex portion and the second shaft portion. The bottom end of the lift cord is inserted into the second hole and fixed to the second worm shaft by a knot.

Preferably, the second worm shaft further has a flange protruding from a periphery wall of the second hole and engaged with the knot.

Preferably, the base has a chamber opened downwards and communicating with the first hole for accommodation of the annular convex portion of the second worm shaft.

Preferably, the driving hole has a crisscross shape for engagement with a hand tool like a cross screwdriver.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is a top perspective view of a hem length adjusting device of the present invention.

FIG. 2 is a bottom perspective view of the hem length adjusting device of the present invention.

FIG. 3 is an exploded perspective view of the hem length adjusting device of the present invention.

FIG. 4 is a partially bottom perspective view of a window blind in which the hem length adjusting device of the present invention is installed.

FIG. 5A is a partially perspective sectional view of the hem length adjusting device of the present invention, showing the lift cord isn't wound around the second worm shaft.

FIG. 5B is similar to FIG. 5A, showing the lift cord is wound around the second worm shaft.

FIG. 6A is a sectional view of a bottom rail in which the hem length adjusting device of the present invention is installed, showing the knot and the flange are engaged with each other.

FIG. 6B is similar to FIG. 6A, showing the lift cord is wound around the second worm shaft.

### DETAILED DESCRIPTION OF THE INVENTION

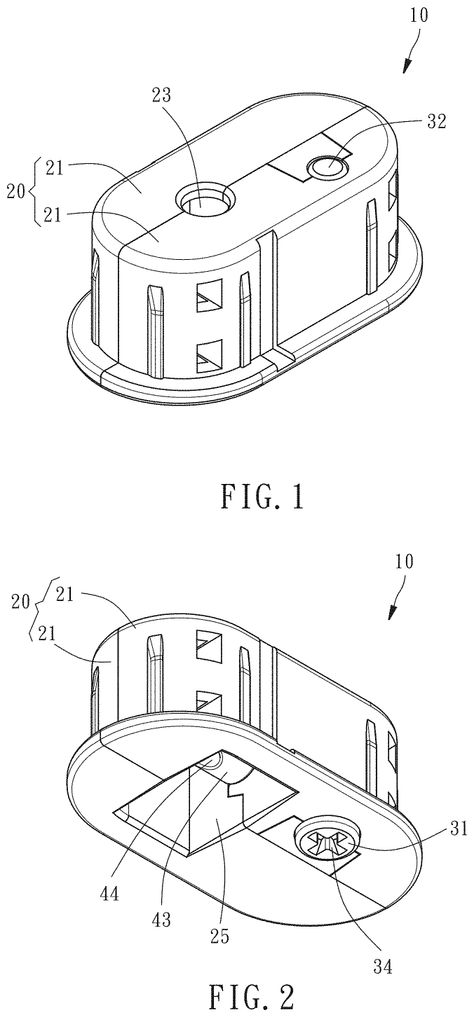

Referring to FIGS. 1 to 3, a hem length adjusting device 10 of the present invention comprises a base 20, a first worm shaft 30, and a second worm shaft 40.

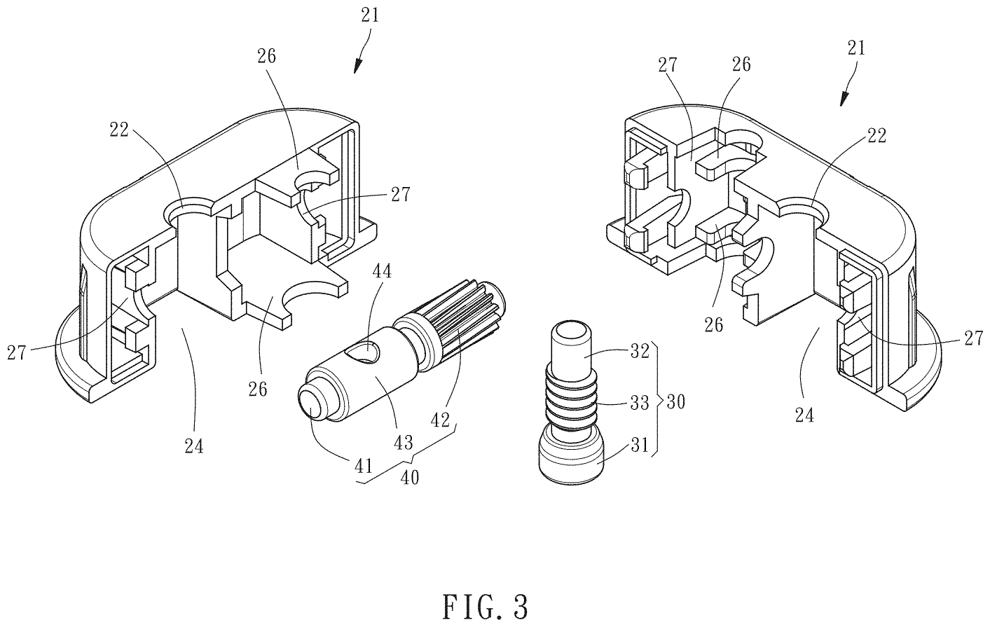

The base 20 includes two half shells 21 fastened together. A curved groove 22 is provided at each of top sides of the half shells 21. As shown in FIG. 1, a first hole 23 is formed by the two curved grooves 22 after the two half shells 21 are fastened together. Each of the two half shells 21 has a recess 24 under the curved groove 22. As shown in FIG. 2, a chamber 25 opened downwards and communicating with the first hole 23 is formed by the two recesses 24 after the two half shells 21 are fastened together. Further, the two half shells 21 each have two first supporting portions 26 arranged in a up and down manner, and two second supporting portions 27 arranged in a front and back manner.

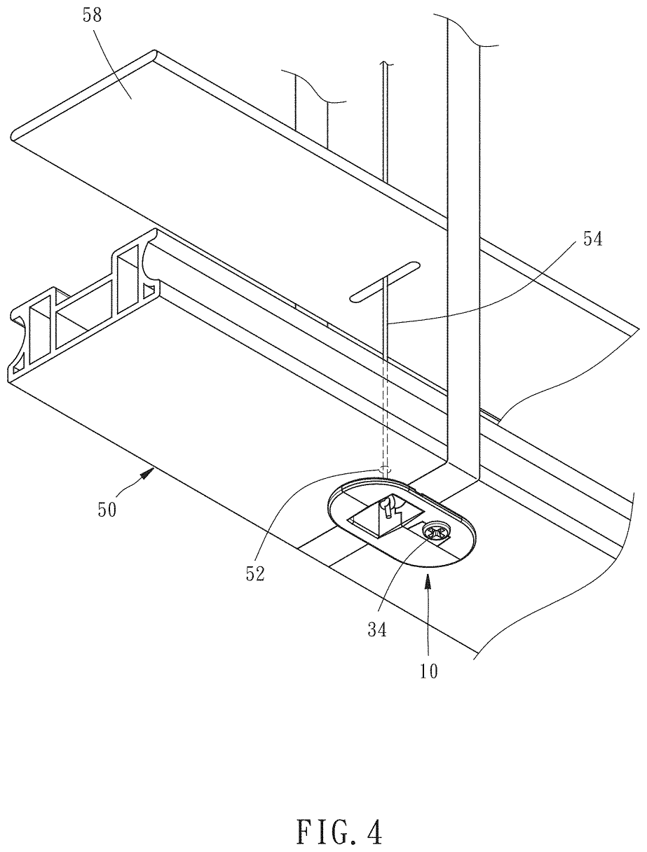

The first worm shaft 30 has a head portion 31 with a cruciform driving hole 34, a first shaft portion 32 provided with a bottom end thereof connected with the head portion 31, and a first teeth portion 33 formed on the outer surface of the first shaft portion 32. As shown in FIG. 3, the first worm shaft 30 is inserted into the base 20 from bottom to up in such a manner that the head portion 31 protrudes from the bottom side of the base 20, and two ends of the first shaft portion 32 are supported by the first supporting portions 26 of the base 20.

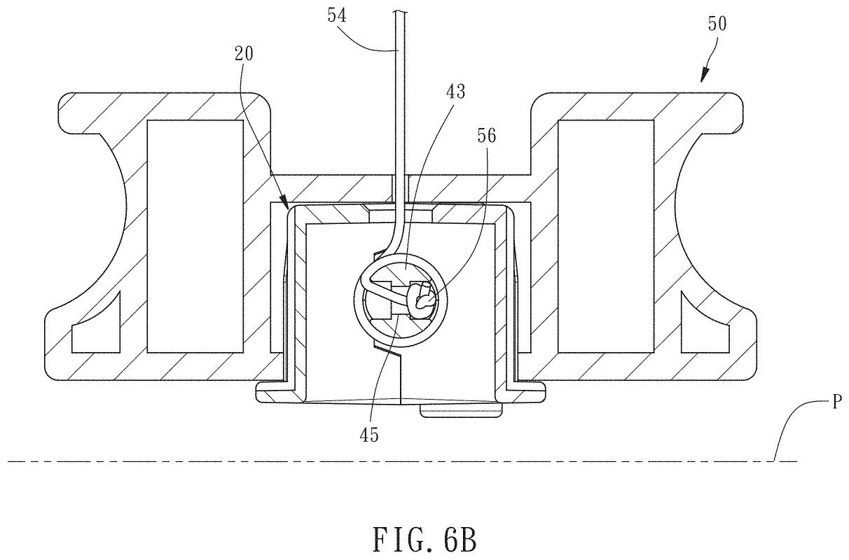

The second worm shaft 40 has a second shaft portion 41, a second teeth portion 42 formed on the outer surface of the second shaft portion 41, and an annular convex portion 43 disposed coaxially on the outer surface of the second shaft portion 41 and spaced from the second teeth portion 42. As shown in FIG. 3, the second worm shaft 40 is inserted horizontally into the base 20 in such a manner that the second teeth portion 42 is meshed with the first teeth portion 33 of the first worm shaft 30, and two ends of the second shaft portion 41 are supported by the second supporting portions 27 of the base 20, and the annular convex portion 43 is received in the chamber 25 of the base 20. Further, the second worm shaft 40 has a second hole 44 passing radially through the annular convex portion 43 and the second shaft portion 41, and a flange 45 protruding from a periphery wall of the second hole 44 (as shown in FIG. 6A).

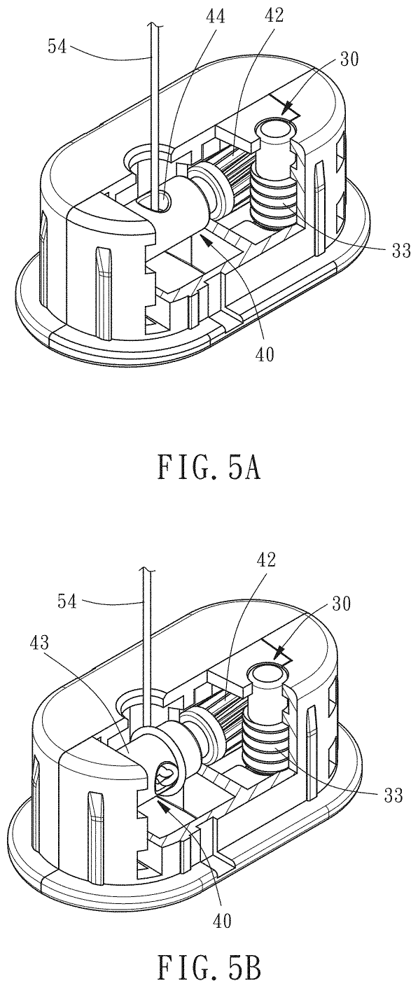

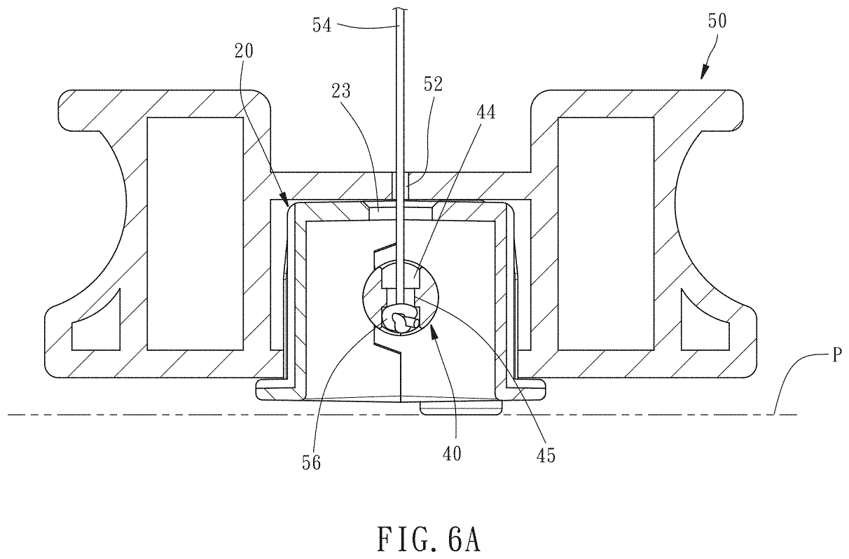

When the hem length adjusting device 10 of the present invention is used in a window blind without exposed pull cord, as shown in FIG. 4 (for illustrative purposes, FIG. 4 only shows a part of the window blind without exposed pull cord), the base 20 is inserted into a bottom rail 50 from the bottom side of the bottom rail 50 in such a manner that the driving hole 34 of the first worm shaft 30 is exposed out of the bottom side of the bottom rail 30 for engagement with a hand tool (such as a cross screwdriver, not shown). As shown in FIGS. 5A and 6A, a lifting cord 54 has a bottom end thereof penetrating into the second hole 44 of the second worm shaft 40 through a top hole 52 of the bottom rail 50 and the first hole 23 of the base 20, and fixed to the second worm shaft 40 by a knot 56 engaged with the flange 45.

When the first worm shaft 30 is driven by the aforesaid hand tool to rotate, the second worm shaft 40 is driven by the first worm shaft 30 to rotate synchronously. During the rotation of the second worm shaft 40, the bottom end of the lifting cord 54 is wound around the annular convex portion 43 of the second worm shaft 40. The lifting cord 54 has a top end thereof penetrating into an upper rail (not shown) and connected with a cord rolling device (not shown, the cooperation between the lifting cord 54 and the cord rolling device is known in the prior art, so the detailed configuration will not be repeatedly mentioned hereunder). By this way, since the top end of the lifting cord 54 is kept still, the bottom rail 50 is raised when the bottom end of the lifting cord 54 is wound around the second worm shaft 40. For example, when the bottom rail 50 is moved from a position shown in FIG. 6A to a position shown in FIG. 6B (an imaginary plane P shown in FIGS. 6A and 6B only illustrates the movement of the bottom rail 50, not the ground), a part of slats 58 are folded by the upward movement of the bottom rail 50. Further, when the bottom rail 50 is raised to a desired level, the first worm shaft 30 can be stopped rotating for retaining the bottom rail 50. As such, even if the whole slats 58 are folded up, the bottom rail 50 can be kept in the adjusted position when the slats 58 are unfolded again. In addition, if a user would like to unfold the whole slats 58, the aforesaid hand tool is used to rotate the first worm shaft 30 in a reverse direction, such that the second worm shaft 40 is driven by the first worm shaft 30 to release the wound lifting cord 54 until the bottom rail 50 is restored to an original position. As described above, the hem length adjusting device 10 of the present invention is used to adjust the height above the ground of the bottom rail 50 according to different environment, thereby enhancing the convenience of operation.

What is claimed is:

1. A hem length adjusting device for use in a window blind without exposed pull cord having a bottom rail and a lifting cord with a bottom end penetrating into the bottom rail, the hem length adjusting device comprising:
a base mounted in the bottom rail and having a first hole for penetration of the lifting cord;
a first worm shaft rotatably disposed in the base and having a head portion protruding from a bottom side of the bottom rail and provided with a driving hole, a first shaft portion provided with a bottom end connected with the head portion, and a first worm teeth portion formed on an outer surface of the fist shaft portion; and
a second worm shaft rotatably disposed in the base and having an axial direction vertical to an axial direction of the first worm shaft, the second worm shaft having a second shaft portion connected with the bottom end of the lifting cord, and a second worm teeth portion formed on an outer surface of the second shaft portion and meshed with the first worm teeth portion of the first worm shaft.

2. The hem length adjusting device as claimed in claim 1, wherein the second worm shaft further has an annular convex portion formed on the outer surface of the second shaft portion and connected with the bottom end of the lifting cord.

3. The hem length adjusting device as claimed in claim 2, wherein the second worm shaft further has a second hole passing radially through the annular convex portion and the second shaft portion; the bottom end of the lift cord is inserted into the second hole and fixed to the second worm shaft by a knot.

4. The hem length adjusting device as claimed in claim 3, wherein the second worm shaft further has a flange protruding from a periphery wall of the second hole and engaged with the knot.

5. The hem length adjusting device as claimed in claim 2, wherein the base has a chamber opened downwards and communicating with the first hole for accommodation of the annular convex portion of the second worm shaft.

6. The hem length adjusting device as claimed in claim 1, wherein the driving hole has a crisscross shape.
